(19) United States
(12) Patent Application Publication
(10) Pub. No.: US 2026/0201935 A1
(43) Pub. Date: Jul. 16, 2026

(54) End Member Assemblies and Gas Spring Assemblies Including Same

(71) Applicant: Firestone Industrial Products Company, LLC, Nashville, TN (US)

(72) Inventors: Machiel G.A. WENTINK, Velp (NL); Corentin A. MORIN, Elst (NL)

(21) Appl. No.: 19/148,984

(22) PCT Filed: Jan. 19, 2024
(86) PCT No.: PCT/US2024/012212

§ 371 Date: Jul. 17, 2025

Related U.S. Application Data
(60) Provisional application No. 63/480,947, filed on Jan. 20, 2023.

(51) Int. Cl. F16F 9/05; B60G 11/27

(52) U.S. Cl. CPC F16F 9/057; B60G 11/27; B60G 2202/152; B60G 2206/424; B60G 2800/162; F16F 2222/126; F16F 2230/02; F16F 2230/36

(57) ABSTRACT

End member assemblies include a first end member section and a second end member section. The first end member section includes a first section wall with a mounting wall portion, a first outer side wall portion and a first inner side wall portion. The mounting wall portion receives a flexible spring member. The first outer side wall portion extends axially toward a first outer distal edge. A passage extends through the first inner side wall portion in fluid communication between first and second end member chambers. The second end member section includes a second section wall. The first and second end member sections are connected to one another at a joint that forms a substantially fluid-tight seal therebetween. The joint is disposed in axially-spaced relation to the flexible spring member in a fully-compressed height thereof. Gas spring assemblies and suspension systems are also included.

### BACKGROUND

The subject matter of the present disclosure broadly relates to the art of gas spring devices and, more particularly, to end member assemblies constructed from a plurality of polymeric end member sections that are attached to one another using integrally formed features. In an assembled condition, such end member assemblies include a smooth and continuous outer surface with the exposed interface or joint between the end member sections positioned toward a distal end of the end member assemblies. Gas spring assemblies including such an end member assembly have a flexible sleeve that is displaced along the smooth and continuous outer surface in axially-spaced relation to the exposed joint. Suspension systems can include one or more of such gas spring assemblies.

The subject matter of the present disclosure may find particular application and use in conjunction with components for wheeled vehicles, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with gas spring assemblies of non-wheeled vehicles, support structures, height adjusting systems and actuators associated with industrial machinery, components thereof and/or other such equipment. Accordingly, the subject matter of the present disclosure is not intended to be limited to use associated with gas spring suspension systems of wheeled vehicles.

Wheeled motor vehicles of most types and kinds include a sprung mass, such as a body or chassis, for example, and an unsprung mass, such as two or more axles or other wheel-engaging members, for example, with a suspension system disposed therebetween. Typically, a suspension system will include a plurality of spring devices as well as a plurality of damping devices that together permit the sprung and unsprung masses of the vehicle to move in a somewhat controlled manner relative to one another. Movement of the sprung and unsprung masses toward one another is normally referred to in the art as jounce motion while movement of the sprung and unsprung masses away from one another is commonly referred to in the art as rebound motion.

In many applications involving vehicle suspension systems, it may be desirable to utilize spring elements that have as low of a spring rate as is practical, as the use of lower spring rate elements can provide improved ride quality and comfort compared to spring elements having higher spring rates. That is, it is well understood in the art that the use of spring elements having higher spring rates (i.e., stiffer springs) will transmit a greater magnitude of road inputs into the sprung mass of the vehicle and that this typically results in a rougher, less-comfortable ride. Whereas, the use of spring elements having lower spring rates (i.e., softer, more-compliant springs) will transmit a lesser amount of road inputs into the sprung mass and will, thus, provide a more comfortable ride.

In some cases, the spring devices can take the form of gas spring assemblies that utilize pressurized gas as the working medium. Gas spring assemblies of various types, kinds and constructions are well known and commonly used. Typical gas spring assemblies can include a flexible wall that is secured between comparatively rigid end members and/or end member assemblies. In such cases, it is generally possible to reduce the spring rate of gas spring assemblies, thereby improving ride comfort, by increasing the volume of pressurized gas operatively associated with the gas spring assembly. This is commonly done by placing an additional chamber, cavity or volume containing pressurized gas into fluid communication with the primary spring chamber of the gas spring assembly. In some cases, the additional volume can be formed within one of the end members of the gas spring assembly.

In some cases, two or more polymeric end member components can be permanently secured together to form an end member assembly. In many cases, such constructions will include a fluid-tight chamber within the end member assembly. However, known constructions of such end member assemblies often undesirably include an exposed interface or joint between adjacent components that is toward the end along which the associated flexible sleeve is connected. As such, in such constructions, the exposed interface or joint is undesirably located within an axial area or zone of the end member assembly that the associated flexible sleeve regularly (i.e., almost constantly) contacts or abuttingly engages during normal use in operation of the gas spring assembly. In cases in which such an exposed interface or joint has unfinished edges or protrudes along the outer side surface, the flexible sleeve can be degraded through movement along and contact with such an exposed interface or joint. To help ensure that the edges of the exposed interface or joint are finished and smooth, additional manufacturing and assembly steps and/or processes may be used that can disadvantageously increase factors such as production time, tooling and equipment costs, and post-assembly operations.

German Patent Publication No. DE 102007035640 discloses a two-piece piston assembly for a gas spring assembly. A lower cup-shaped section includes an outer side wall. An upper cover section includes a mounting wall for receiving an end of a flexible sleeve. The upper cover section is secured to the lower cup-shaped section at the distal end of the outer side wall by way of an air-tight joint that is disposed near the mounting wall. The air-tight joint is located underneath the flexible sleeve and is contacted thereby during normal use.

European Patent No. 1862335 discloses a two-piece piston assembly for use in gas spring assemblies. The embodiment includes a lower cup-shaped portion with an outer side wall. An upper annular cover includes a mounting wall dimensioned to receive an end of a flexible sleeve. The upper cover is secured to the outer side wall of the lower cup-shaped portion by way of a weld joint disposed near the mounting wall, which will be located underneath and contacted by the flexible sleeve during normal use.

European Patent No. 2723588 discloses various embodiments of two-piece piston assemblies for use in gas spring assemblies. The various embodiments include a lower part with an outer side wall. An annular cover has a wall for receiving an end of a flexible sleeve. The annular cover is attached to a distal end of the outer side wall of the lower part by way of a butt-weld joint that forms an air-tight seal between the parts. The joint is disposed near the wall that receives the end of the flexible sleeve such that the joint is located beneath and contacted by the flexible sleeve during normal use.

U.S. Pat. No. 9,334,916 discloses a gas spring assembly with a two-piece piston assembly. An upper cover part includes a wall to which a flexible sleeve is secured. A lower base part has a pot-shaped configuration with an axially-extending outer side wall. The upper cover part is attached to the lower base part at a butt-welded connection disposed at an upper end of the piston assembly. The butt-welded connection is disposed underneath and contacted by the flexible sleeve during normal use of the gas spring assembly.

Notwithstanding the broad usage and overall success of the wide variety of end member constructions that are known in the art, it is believed that a need exists to develop end member assemblies that avoid or otherwise overcome the foregoing and/or other disadvantages of known constructions, and/or otherwise advance the art of gas spring devices while still retaining comparable or even improving factors such as performance, ease of manufacture, ease of assembly, ease of installation and/or cost of manufacture.

### BRIEF SUMMARY

One example of an end member assembly in accordance with the subject matter of the present disclosure can have a longitudinal axis and can be dimensioned to receivingly engage an associated flexible spring member for forming an associated gas spring assembly. The end member assembly can include first and second end member sections. The first end member section can include a first section wall extending peripherally about the longitudinal axis. The first section wall can include a first end wall portion oriented transverse to the longitudinal axis. The first section wall can also include a mounting wall portion extending from along the first end wall portion in a first axial direction. The mounting wall portion can be dimensioned to sealingly engage the associated flexible spring member. The section wall can further include a first outer side wall portion and a first inner side wall portion. The first outer side wall portion can extend from along the first end wall portion in a second axial direction that is opposite the first axial direction toward a first outer distal edge that is axially offset from the first end wall portion by a first outer side wall distance. The first outer side wall portion can be disposed radially outward of the mounting wall portion and can at least partially define a first end member chamber. The first inner side wall portion can be disposed radially inward of the first outer side wall portion and can extend from along the first end wall portion toward a first inner distal edge that is axially offset from the first end wall portion by a first inner side wall distance that is less than the first outer side wall distance of the first outer side wall portion such that a recess extends into the first end member section from along the first outer distal edge. The recess can have a frustoconical or concave shape projected between the first inner distal edge and the first outer distal edge. The second end member section can include a second section wall extending peripherally about the longitudinal axis. The second section wall can include a second end wall portion oriented transverse to the longitudinal axis. The second end wall portion can include an outer peripheral edge. A second inner side wall portion can extend from along the second end wall portion in the first axial direction toward a second inner distal edge that is axially offset from at least one of the second end wall portion and the outer peripheral edge by a second inner side wall distance such that the second end member has a frustoconical or convex shape projected between the second inner distal edge and the outer peripheral edge of the second end wall portion. The second end member section can be at least partially received within the recess of the first end member section such that the first and second inner distal edges are disposed adjacent one another. The first and second end member sections are connected to one another along a first flowed-material joint formed between the first outer distal edge and the outer peripheral edge such that a substantially fluid-tight seal is formed therebetween.

Another example of an end member assembly in accordance with the subject matter of the present disclosure can have a longitudinal axis and can be dimensioned to receivingly engage an associated flexible spring member for forming an associated gas spring assembly. The end member assembly can include a first end member section and a second end member section. The first end member section can include a first section wall extending peripherally about the longitudinal axis. The first section wall can include a first end wall portion, a mounting wall portion, a first outer side wall portion and a first inner side wall portion. The first end wall portion can be oriented transverse to the longitudinal axis. The mounting wall portion can extend from along the first end wall portion in a first axial direction and can be dimensioned to sealingly engage the associated flexible spring member. The first outer side wall portion can be disposed radially outward of the mounting wall portion. The first outer side wall portion can include a first outer side surface portion and a first inner side surface portion. The first outer side wall portion can extend in a second axial direction opposite the first axial direction toward a first outer distal edge. The first inner side wall portion can be disposed radially inward of the first outer side wall portion. The first inner side wall portion can include a second outer side surface portion and a second inner side surface portion. The second outer side surface can be disposed in facing relation to the first inner side surface portion such that a first end member chamber is at least partially defined therebetween. The second inner side surface portion can at least partially define a second end member chamber disposed radially inward of at least a portion of the first end member chamber. At least one passage can extend through the first inner side wall portion in fluid communication between the first and second end member chambers. The second end member section can include a second section wall extending peripherally about the longitudinal axis. The second section wall can include an end wall portion that is oriented transverse to the longitudinal axis. The end wall portion can include an outer peripheral edge. The first and second end member sections can be connected to one another with a flowed-material joint formed between the first outer distal edge and the outer peripheral edge such that a substantially fluid-tight seal is formed therebetween. The flowed-material joint can be positioned toward an end of the end member assembly opposite the mounting wall portion such that the flowed-material joint is offset in the second axial direction from the associated flexible spring member in an associated fully-compressed height of the associated gas spring assembly.

One example of a gas spring assembly in accordance with the subject matter of the present disclosure can include a flexible spring member having a longitudinal axis. The flexible spring member can include a flexible wall extending peripherally about the longitudinal axis between a first end and a second end of the flexible spring member to at least partially define a spring chamber therebetween. An end member can be secured across the first end of the flexible spring member such that a substantially fluid-tight connection is formed therebetween. An end member assembly according to either one of the foregoing two paragraphs can be secured across the second end of the flexible spring member such that a substantially fluid-tight connection is formed therebetween.

One example of a gas spring assembly in accordance with the subject matter of the present disclosure can include a flexible spring member having a longitudinal axis. The flexible spring member can include a flexible wall extending peripherally about the longitudinal axis between a first end and a second end of the flexible spring member to at least partially define a spring chamber therebetween. An end member can be secured across the first end of the flexible spring member such that a substantially fluid-tight connection is formed therebetween. An end member assembly can be secured across the second end of the flexible spring member such that a substantially fluid-tight connection is formed therebetween. The end member assembly can include first and second end member sections. The first end member section can include a first section wall extending peripherally about the longitudinal axis. The first section wall can include a mounting wall portion at least partially defining an open end of the end member assembly and dimensioned to sealingly engage the flexible spring member. The first section wall can also include a first outer side wall portion disposed radially outward of the mounting wall portion. The first outer side wall portion can include a first outer side surface portion and a first inner side surface portion. The first outer side wall portion can extend axially toward a first outer distal edge disposed axially opposite the mounting wall portion. The first section wall can further include a first inner side wall portion disposed radially inward of the first outer side wall portion. The first inner side wall portion can include a second outer side surface portion and a second inner side surface portion. The second outer side surface can be disposed in facing relation to the first inner side surface portion such that a first end member chamber is at least partially defined therebetween. The second inner side surface portion can at least partially define a second end member chamber disposed radially inward of at least a portion of the first end member chamber. The second end member chamber can be disposed in fluid communication with the spring chamber through the open end of the first end member section. At least one passage can extend through the first inner side wall portion in fluid communication between the first and second end member chambers. The second end member section can include a second section wall extending peripherally about the longitudinal axis. The second section wall can include an end wall portion that is oriented transverse to the longitudinal axis. The end wall portion can extend radially outward to an outer peripheral edge. The first and second end member sections can be connected to one another with a flowed-material joint formed between the first outer distal edge and the outer peripheral edge such that a substantially fluid-tight seal is formed therebetween. The flowed-material joint can be disposed in axially-spaced relation to the flexible spring member at the fully-compressed height of the gas spring assembly.

One example of a suspension system in accordance with the subject matter of the present disclosure can include a pressurized gas system including a pressurized gas source and a control device in fluid communication with the pressurized gas source. At least one gas spring assembly in accordance with either one of the foregoing two paragraphs can be disposed in fluid communication with the pressurized gas source through the control device.

### BRIEF DESCRIPTION OF THE DRAWINGS

FIG. 1 is a schematic representation of one example of a suspension system of an associated vehicle including a gas spring assembly in accordance with the subject matter of the present disclosure.

FIG. 2 is a side elevation view of one example of a gas spring assembly that includes one example of an end member assembly in accordance with the subject matter of the present disclosure.

FIG. 3 is a partial cross-sectional side view of the gas spring assembly in FIG. 2 taken from along line 3-3 in FIG. 2 and representing design and fully-compressed heights of the gas spring assembly.

FIG. 4 is top perspective view of the end member assembly in FIGS. 2 and 3.

FIG. 5 is a top plan view of the end member assembly in FIGS. 2-4.

FIG. 6 is a cross-sectional side view of the end member assembly in FIGS. 2-5 taken from along line 6-6 in FIG. 5.

FIG. 7 is a side elevation view showing components of the end member assembly in FIGS. 2-6 prior to assembly.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purposes of clarity and/or ease of understanding.

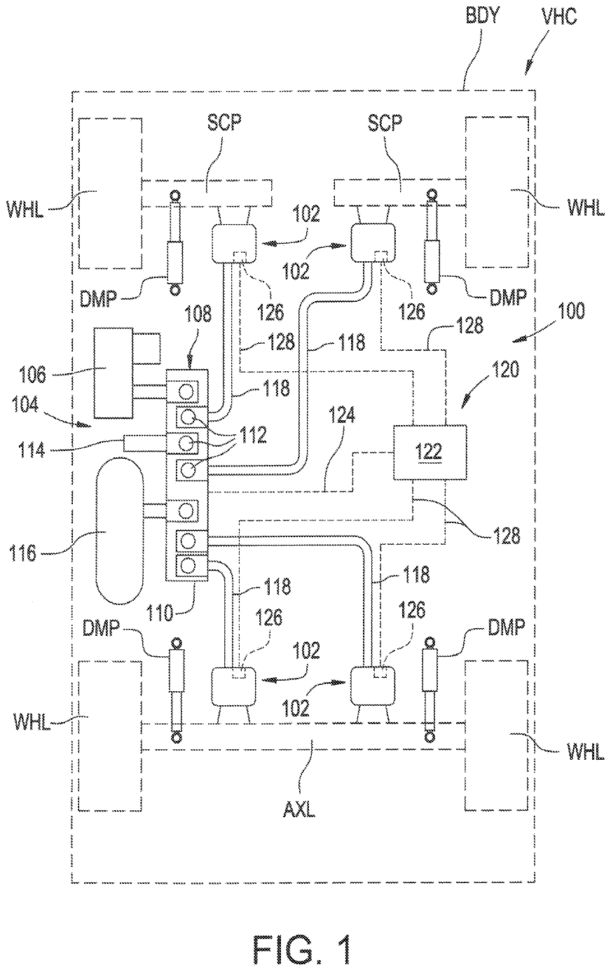

FIG. 1 illustrates one example of a suspension system 100 disposed between a sprung mass, such as an associated vehicle body BDY, for example, and an unsprung mass, such as an associated wheel WHL, an associated suspension component SPC and/or an associated axle AXL, for example, of an associated vehicle VHC. It will be appreciated that any one or more of the components of the suspension system can be operatively connected between the sprung and unsprung masses of the associated vehicle in any suitable manner. Additionally, it will be appreciated that such a suspension system of the vehicle can also, optionally, include a plurality of damping members, such as dampers DMP, for example, and that any such damping members can also be operatively connected between the sprung and unsprung masses of the associated vehicle in any suitable manner.

The suspension system can also include a plurality of gas spring assemblies supported between the sprung and unsprung masses of the associated vehicle. In the arrangement shown in FIG. 1, suspension system 100 includes four gas spring assemblies 102, one of which is disposed toward each corner of the associated vehicle adjacent a corresponding wheel WHL. However, it will be appreciated that any other suitable number of gas spring assemblies could alternately be used in any other configuration or arrangement. As shown in FIG. 1, gas spring assemblies 102 are supported between body BDY and suspension component SPC and/or axle AXL of associated vehicle VHC. Additionally, it will be recognized that the gas spring assemblies shown and described in FIG. 1 (e.g., gas spring assemblies 102) are illustrated as being of a rolling lobe-type construction. It is to be understood, however, that gas spring assemblies of other types, kinds and/or constructions could alternately be used.

Suspension system 100 also includes a pressurized gas system 104 operatively associated with the gas spring assemblies for selectively supplying pressurized gas (e.g., air) thereto and selectively transferring pressurized gas therefrom. In the exemplary embodiment shown in FIG. 1, pressurized gas system 104 includes a pressurized gas source, such as a compressor 106, for example, for generating pressurized air or other gases. A control device, such as a valve assembly 108, for example, is shown as being in communication with compressor 106 and can be of any suitable configuration or arrangement. In the exemplary embodiment shown, valve assembly 108 includes a valve block 110 with a plurality of valves 112 supported thereon. Valve assembly 108 can also optionally include a suitable exhaust, such as a muffler 114, for example, for venting pressurized gas from the system. Optionally, pressurized gas system 104 can also include a reservoir 116 in fluid communication with the compressor and/or valve assembly 108 and suitable for storing pressurized gas.

Valve assembly 108 is in communication with gas spring assemblies 102 through suitable gas transfer lines 118. As such, pressurized gas can be selectively transferred into and/or out of the gas spring assemblies through valve assembly 108 by selectively operating valves 112, such as to alter or maintain vehicle height at one or more corners of the vehicle, for example.

Suspension system 100 can also include a control system 120 that is capable of communication with any one or more systems and/or components of vehicle VHC and/or suspension system 100, such as for selective operation and/or control thereof. Control system 120 can include a controller or electronic control unit (ECU) 122 communicatively coupled with compressor 106 and/or valve assembly 108, such as through a conductor or lead 124, for example, for selective operation and control thereof, which can include supplying and exhausting pressurized gas to and/or from gas spring assemblies 102. Controller 122 can be of any suitable type, kind and/or configuration.

Control system 120 can also, optionally, include one or more height (or distance) sensing devices 126, such as, for example, may be operatively associated with the gas spring assemblies and capable of outputting or otherwise generating data, signals and/or other communications having a relation to a height of the gas spring assemblies or a distance between other components of the vehicle. Such height sensing devices can be in communication with ECU 122, which can receive the height or distance signals therefrom. The height sensing devices can be in communication with ECU 122 in any suitable manner, such as through conductors or leads 128, for example. Additionally, it will be appreciated that the height sensing devices can be of any suitable type, kind and/or construction.

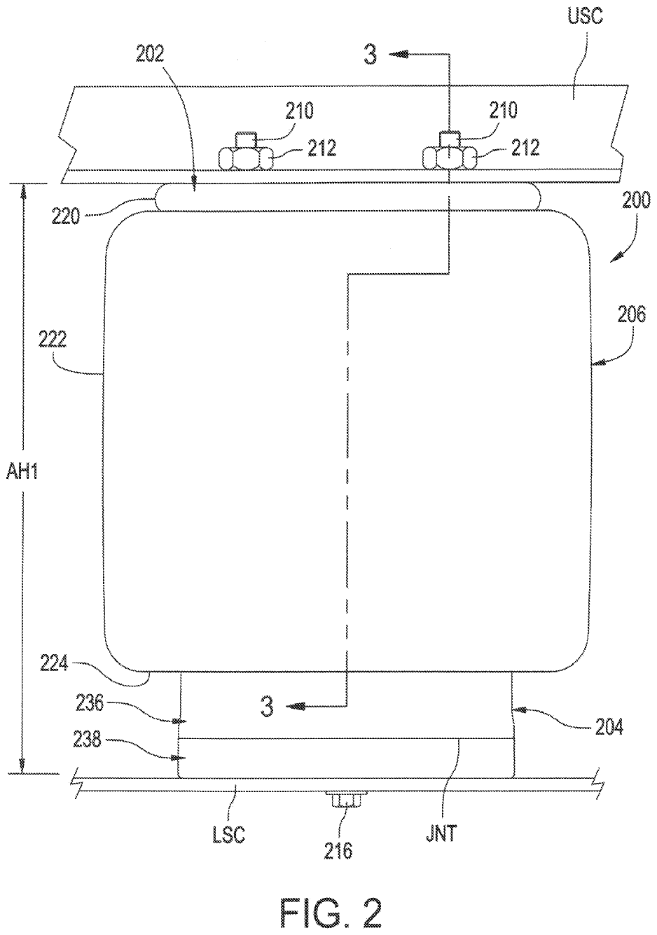

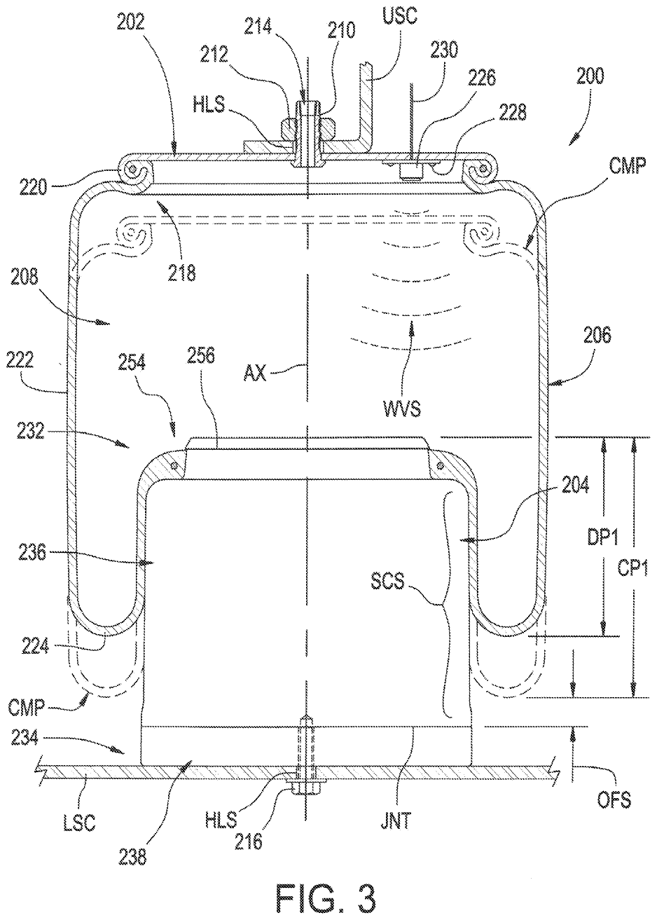

One example of a gas spring assembly 200 in accordance with the subject matter of the present disclosure is shown in FIGS. 2 and 3 as having a longitudinally-extending axis AX (FIG. 3) and can include one or more end members, such as an end member 202 and an end member 204 (which may also be referred to herein as an end member assembly) that is spaced longitudinally from end member 202. A flexible spring member 206 can extend peripherally around axis AX and can be secured between the end members in a substantially fluid-tight manner such that a spring chamber 208 (FIG. 3) is at least partially defined therebetween.

Gas spring assembly 200 can be disposed between associated sprung and unsprung masses of an associated vehicle in any suitable manner such that a substantially fluid-tight connection is formed therebetween. For example, one end member can be operatively connected to the associated sprung mass with the other end member disposed toward and operatively connected to the associated unsprung mass. In the embodiment shown in FIGS. 2 and 3, for example, end member 202 is secured along a first or upper structural component USC, such as associated vehicle body BDY in FIG. 1, for example, and can be secured thereon in any suitable manner. For example, one or more securement devices, such as mounting studs 210, for example, can be included along end member 202. In some cases, the one or more securement devices (e.g., mounting studs 210) can project outwardly from end member 202 and can be secured thereon in a suitable manner, such as, for example, by way of a flowed-material joint (not shown) or a press-fit connection (not identified). Additionally, such one or more securement devices can extend through mounting holes HLS in upper structural component USC and can receive one or more threaded nuts 212 or other securement devices, for example. As an alternative to one or more of mounting studs 210, one or more threaded passages (e.g., blind passages and/or through passages) could be used in conjunction with a corresponding number of one or more threaded fasteners.

Additionally, a fluid communication port, such as a transfer passage 214 (FIG. 3), for example, can optionally be provided to permit fluid communication with spring chamber 208, such as may be used for transferring pressurized gas into and/or out of the spring chamber, for example. In the exemplary embodiment shown, transfer passage 214 extends through at least one of mounting studs 210 and is in fluid communication with spring chamber 208. It will be appreciated, however, that any other suitable fluid communication arrangement could alternately be used.

End member assembly 204 can be secured along a second or lower structural component LSC, such as a suspension component SPC or an axle AXL in FIG. 1, for example, in any suitable manner. As one example, lower structural component LSC could include one or more mounting holes HLS extending therethrough. In such case, a threaded fastener 216 could extend through one of mounting holes HLS and threadably engage end member assembly 204 (or one or more components thereof) to secure the end member assembly on or along the lower structural component.

It will be appreciated that the one or more end members can be of any suitable type, kind, construction and/or configuration, and can be operatively connected or otherwise secured to the flexible wall in any suitable manner. In the exemplary arrangement shown in FIGS. 2 and 3, for example, end member 202 is of a type commonly referred to as a bead plate and is secured to a first end 218 of flexible spring member 206 using a crimped-edge connection 220. End member assembly 204 is shown in the exemplary arrangement in FIGS. 2 and 3 as being of a type commonly referred to as a piston (or a roll-off piston) that has an outer surface 222 that abuttingly engages flexible spring member 206 such that a rolling lobe 224 is formed therealong. In a preferred arrangement, outer surface 222 is smooth and continuous along at least a portion of end member assembly 204 such that, as gas spring assembly 200 is displaced between extended and collapsed conditions, rolling lobe 224 is axially displaced along outer surface 222 in an otherwise conventional manner.

With reference to FIG. 3, in some cases, a height or distance sensing device 226 can, optionally, be disposed within spring chamber 208, such as by being secured along end member 202 using suitable fasteners 228. Height sensing device 226 can be of any suitable type, kind and/or construction, such as an ultrasonic sensor that transmits and receives ultrasonic waves WVS, for example. Additionally, it will be appreciated that height sensing device 226 can be connected to other systems and/or components of a vehicle suspension system in any suitable manner. As shown in FIG. 3, for example, height sensing device 226 includes a lead or connection 230 that can be used for such communication purposes, such as is indicated by leads 128 of height sensing devices 126 of control system 120 in FIG. 1, for example.

An end member assembly in accordance with the subject matter of the present disclosure is formed from a plurality of end member components or sections that are attached to one another such that a substantially fluid-tight connection is formed therebetween. In some cases, an end member in accordance with the subject matter of the present disclosure can at least partially define one or more end member chambers. Additionally, or in the alternative, the plurality of end member components or sections of an end member assembly in accordance with the subject matter of the present disclosure can, in some cases, be attached to one another with an attachment joint that is externally exposed on or along an outer side surface of the end member assembly. In some cases, the end member assembly can include an area or zone along which a rolling lobe of the associated flexible spring member of the associated gas spring assembly is typically displaced during conventional use in operation. In such cases, the externally-exposed attachment joint is preferably positioned in axially-spaced relation to (i.e., outside of or otherwise axially away from) any such area or zone. That is, an end member assembly in accordance with the subject matter of the present disclosure can, optionally, include a smooth and continuous outer surface portion on or along which the rolling lobe can travel during normal use in operation with the attachment joint spaced axially away from (i.e., outside of) such an area or zone such that the attachment joint remains externally exposed and otherwise uncovered by the flexible spring member and rolling lobe thereof during normal use in operation. Furthermore, or as a further alternative, an end member assembly in accordance with the subject matter of the present disclosure can, optionally, include first and second inner wall portions that at least partially form an internal column operable to transfer axial forces and/or loads through the end member assembly. In some cases, the subject construction can allow for modularity in that one end member section can be suitable for use in combination with a variety of different other end member sections, such as may have different side wall profiles or contours (e.g., to allow for tuning of spring rate), different axial heights (e.g., to provide axial stroke or other performance characteristics) or any combination thereof.

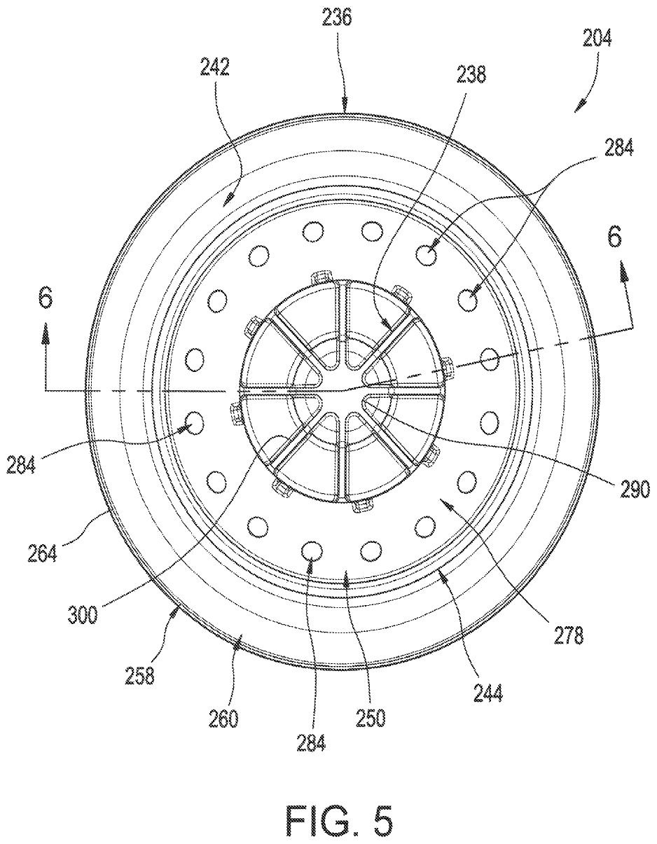

One example of a suitable construction for an end member assembly in accordance with the subject matter of the present disclosure is shown in FIGS. 2-6 as end member assembly 204. The end member assembly can extend from along a first or upper end 232 toward a second or lower end 234 that is spaced longitudinally from end 232. End member assembly 204 can include an end member component or section 236 that is disposed toward end 232 of the end member assembly and an end member component or section 238 that is disposed toward end 234 of the end member assembly and operatively connected to end member section 236. It will be appreciated that in some constructions, one or more features of either one of end member section 236 and end member section 238 can, optionally, be included on or along the other one of end member section 236 and end member section 238 without departing from the subject matter of the present disclosure. As such, it is to be recognized and understood that the specific constructions shown and described herein are merely exemplary and not intended to be limiting.

In some applications and/or conditions of use, end member section 236 can take the form of a first or upper section of the end member assembly and, as such, can include one or more features suitable for operative engagement with an end of flexible spring member 206. For example, end member section 236 can include a section wall 240 that extends peripherally about axis AX. Section wall 240 can include an end wall portion 242 that is oriented transverse to axis AX. A mounting wall portion 244 can extend peripherally about axis AX and axially from along end wall portion 242 toward a distal edge 246. Mounting wall portion 244 can include an inner surface portion 248 that at least partially defines an opening 250 into and/or through end member section 236. Mounting wall portion 244 can also include an outer surface portion 252 that can be dimensioned to receive and form a substantially fluid-tight seal with an end 254 of flexible spring member 206. In some cases, an annular ridge or one or more projections 256 can extend radially outward beyond outer surface portion 252, such as may be useful for engaging or otherwise at least partially retaining end 254 of flexible spring member 206 on or along mounting wall portion 244.

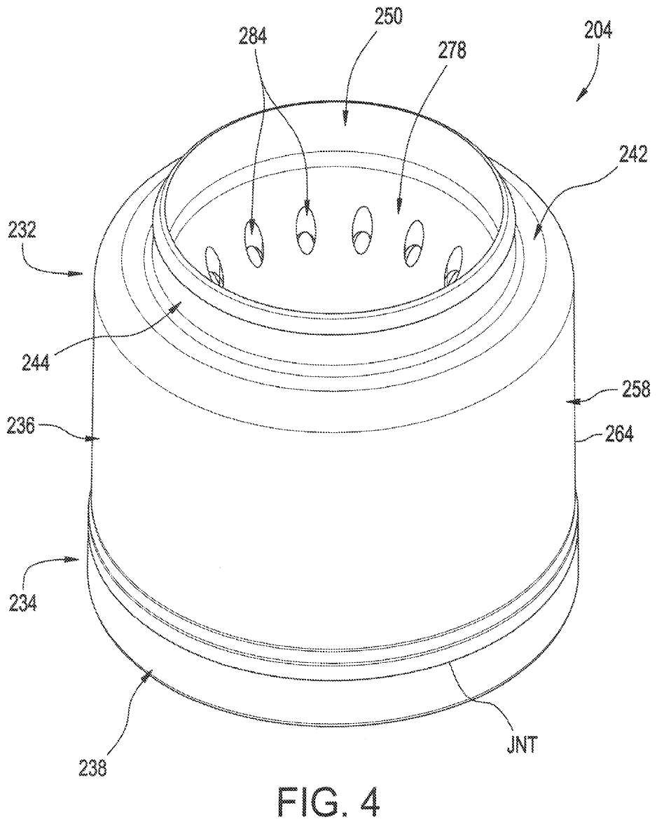

Section wall 240 of end member section 236 can also include an outer side wall portion 258 that extends peripherally about axis AX and axially from along end wall portion 242 in a direction generally opposite distal edge 246 of mounting wall portion 244. Outer side wall portion 258 is disposed radially outward of mounting wall portion 244 and transitions to end wall portion 242 at a shoulder wall portion 260. Outer side wall portion 258 can extend from along shoulder wall portion 260 toward a distal surface or edge 262 that extends annularly around axis AX. Outer side wall portion 258 can include an outer side surface portion 264 and an inner side surface portion 266. Section wall 240 of end member section 236 can further include an inner side wall portion 268 that extends peripherally about axis AX. Inner side wall portion 268 extends from along end wall portion 242 and/or from along mounting wall portion 244 toward a distal edge 270. In some cases, inner side wall portion 268 can have an approximately cylindrical overall shape or configuration. In other cases, inner side wall portion 268 can have a cross-sectional shape or profile that is oriented at an acute included angle relative to longitudinal axis AX, such as is represented in FIG. 4 by angular dimension AG1. In such cases, the inner side wall portion can have an approximately frustoconical overall shape or configuration. Inner side wall portion 268 is disposed radially inward of outer side wall portion 258. Inner side wall portion 268 can include an outer side surface portion 272 facing toward inner side surface portion 266 such that an end member chamber 274 is at least partially defined therebetween. Inner side wall portion 268 can also include an inner side surface portion 276 facing opposite outer side surface portion 272 with an end member chamber 278 at least partially defined thereby radially inward of at least a portion of end member chamber 274. In some cases, a plurality of connecting wall portions or ribs 280 can extend between and operatively interconnect outer side wall portion 258 and inner side wall portion 268. If included, connecting wall portions 280 can be disposed along and operatively connected to end wall portion 242. Additionally, or in the alternative, connecting wall portions 280, if included, can extend axially from adjacent or otherwise along end wall portion 242 toward distal edges 282, which can have a linear or curvilinear shape or configuration.

In an assembled condition of gas spring assembly 200, end 254 of flexible spring member 206 is received in a substantially fluid-tight manner on or along end member assembly 204, such as on or along mounting wall portion 244 of section wall 240 thereof, for example. In such an arrangement, spring chamber 208 is disposed in fluid communication with end member chamber 278 through opening 250. In some cases, one or more openings or passages 284 can extend through inner side wall portion 268 such that end member chamber 278 is disposed in fluid communication with end member chamber 274 through at least passages 284. In a preferred arrangement, a plurality of passages 284 can be disposed in peripherally-spaced relation to one another around axis AX.

Again, in some applications and/or conditions of use, end member section 238 can take the form of a second or lower section of the end member assembly. As such, end member section 238 can include one or more features suitable for operatively connecting the end member assembly to an adjacent structural component, such as lower structural component LSC, for example. As a non-limiting example, end member section 238 can include a section wall 286 that extends peripherally about axis AX. Section wall 286 can include an end wall portion 288 that is oriented transverse to axis AX and dimensioned to abuttingly engage an adjacent structural component, such as lower structural component LSC, for example. Additionally, or as an alternative, section wall 286 can, optionally, include one or more securement devices operatively connected therewith. For example, section wall 286 could include one or more boss wall portions 290 within which a securement device 292 (e.g., a connector threaded fitting or threaded fastener) can be at least partially embedded or otherwise operatively connected. It will be appreciated, however, that other configurations or arrangements for operatively engaging one or more securement devices can alternately be used without departing from the subject matter of the present disclosure.

Section wall 286 can extend radially outward to an outer peripheral edge 294 that extends peripherally around longitudinal axis AX. Section wall 286 can also include an inner side wall portion 296 that extends peripherally about axis AX and axially from along end wall portion 288 toward a distal edge 298. In some cases, section wall 286 can include a plurality of connecting wall portions or ribs 300 that extend between and operatively interconnect boss wall portions 290 and inner side wall portion 296, such as by extending from along end wall portion 288 toward distal edges 302. As one non-limiting example, connecting wall portions 300 can, if included, be arranged in a peripherally-spaced relation to one another about axis AX. Additionally, or in the alternative, section wall 286 can, optionally, include a plurality of connecting wall portions or ribs 304 that extend between and operatively interconnect inner side wall portion 296 and outer peripheral edge 294, such as by extending from along end wall portion 288 toward distal edges 306. As one non-limiting example, connecting wall portions 304 can be arranged in a peripherally-spaced relation to one another about axis AX.

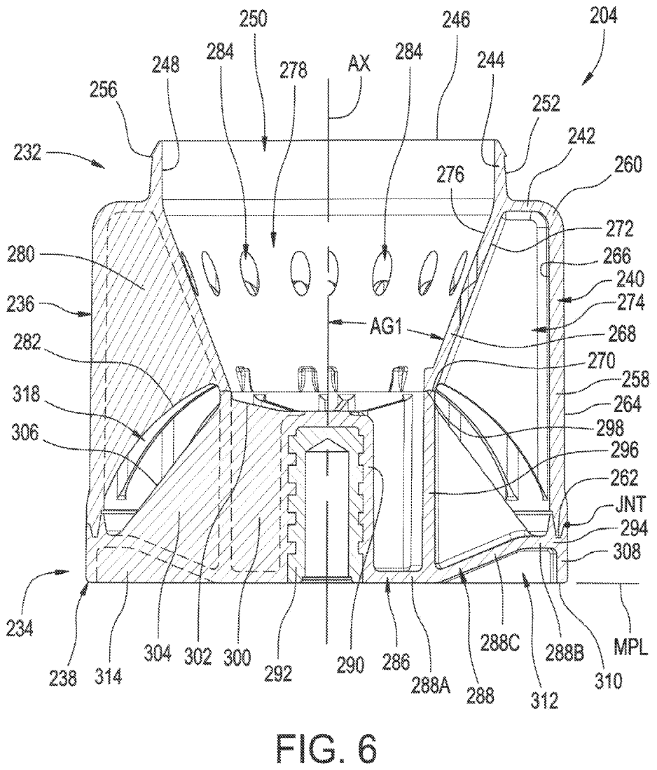

In some cases, end wall portion 288 can be approximately planar. In other cases, end wall portion 288 can have a non-planar profile or cross-sectional shape, such as is shown in FIG. 6, for example. In such cases, end wall portion 288 can include two or more wall profile segments. In the arrangement shown, end wall portion 288 includes a wall profile segment 288A that approximately defines a mounting plane MPL for end member section 238 and end member assembly 204. End wall portion 288 also includes a wall profile segment 288B that is axially offset from wall profile segment 288A in a direction toward distal edge 298 of inner side wall portion 296. In such an arrangement, a wall profile segment 288C can extend between and operatively connect wall profile segments 288A and 288B. The axial offset of wall profile segments 288B and 288C can, in some cases, leave outer peripheral edge 294 unsupported in spaced relation to mounting plane MPL. In other cases, section wall 286 can include an extension wall portion 308 that extends axially from along outer peripheral edge 294 toward an extension distal edge 310, which can be disposed in approximate alignment with mounting plane MPL and thereby at least partially support the outer peripheral edge of end member section 238. In some cases, a cavity 312 can be at least partially defined between wall profile segments 288B and 288C together with extension wall portion 308, if included. In some cases, cavity 312 can extend annularly around longitudinal axis AX. In other cases, section wall 286 can, optionally, include a plurality of connecting wall portions or ribs 314 that extend between and operatively interconnect end wall portion 388 and extension wall portion 308. As one non-limiting example, connecting wall portions 314 can be arranged in a peripherally-spaced relation to one another about axis AX.

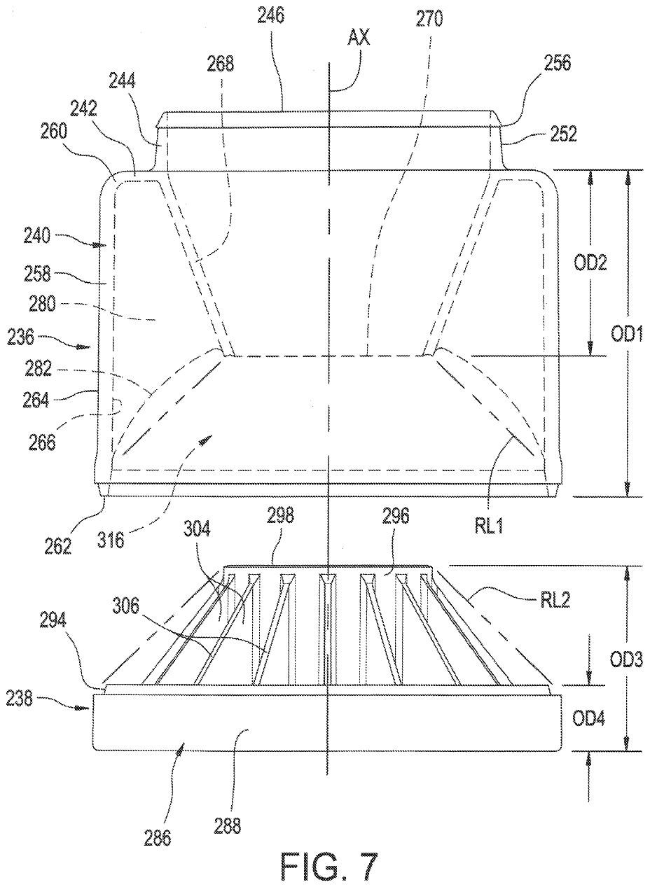

In some cases, end member sections 236 and 238 can be constructed such that one end member section is at least partially received within the other end member section. As one non-limiting example, distal edge 262 of outer side wall portion 256 can be offset or otherwise axially spaced a distance from end wall portion 242, such as is represented by reference dimension OD1 in FIG. 7. Additionally, distal edge 270 of inner side wall portion 268 can be offset or otherwise axially spaced a distance from end wall portion 242, such as is represented by reference dimension OD2 in FIG. 7. In a preferred arrangement, offset distance OD2 is substantially less than offset distance OD1, such as offset distance OD2 having a value within a range of from approximately twenty-five (25) percent to approximately ninety (90) percent of offset distance OD1, for example. In such case, a reference line RL1 projected from distal edge 262 to distal edge 270 and swept around longitudinal axis AX will generate or otherwise approximately define a recess 316 within end member section 236 that has an approximately frustoconical or concave shape and/or configuration, such as may at least partially depend on the shape and/or configuration of distal edges 282 of connecting wall portions 280, for example.

With continued reference to the foregoing non-limiting example, distal edge 298 of inner side wall portion 296 of end member section 238 can be offset or otherwise axially spaced a distance from end wall portion 288, such as is represented in FIG. 7 by reference dimension OD3. In some cases, outer peripheral edge 294 can project from along end wall portion 288 (whether having a planar or non-planar profile, as discussed above) by a small amount, such as a distance suitable for providing additional material for the formation of a joint or other connection, for example. For illustrative purposes, such an offset distance is represented in FIG. 7 by reference dimension OD4. In a preferred arrangement, offset distance OD4 is substantially less than offset distance OD3, such as offset distance OD4 having a value within a range of from approximately zero (0) percent to approximately forty (40) percent of offset distance OD3, for example. In such case, a reference line RL2 projected from outer peripheral edge 294 to distal edge 298 and swept around longitudinal axis AX will generate or otherwise approximately define an approximately frustoconical or convex shape and/or configuration of end member section 238, such as may at least partially depend on the shape and/or configuration of distal edges 306 of connecting wall portions 304, for example.

In an assembled condition, at least a portion of the approximately frustoconical or convex shape of end member section 238 can be received within recess 308 of end member section 236. In a preferred arrangement, end member sections 236 and 238 are assembled such that distal edge 270 of inner side wall portion 268 and distal edge 298 of inner side wall portion 296 cooperatively interengage one another, such as by way of inter-engaging geometric features (e.g., cooperative grooves, shoulders and/or v-shaped cross-sectional profiles). In such an arrangement, end member sections 236 and 238 are capable of transmitting or otherwise carrying axial loads and/or forces through end member assembly 200, such as may be transferred into the end member assembly by a load carried by the gas spring assembly or an input force from an internal jounce bumper, for example.

Additionally, in such an assembled condition, distal edges 282 of connecting wall portions 280 and distal edges 306 of connecting wall portions 304 are disposed in axially-spaced relation to one another such that an annular gap or channel 318 is disposed therebetween. Annular channel 318 is operative to permit fluid communication among and between connecting wall portions 280 and 304 such that end member chamber 274 functions as a contiguous volume, which can, optionally, be combined with end member chamber 278, such as by way of fluid communication through passages 284, as discussed above.

As discussed above, end member sections 236 and 238 are secured together to form end member assembly 200. It will be appreciated that end member sections 236 and 238 can be secured together in any manner and/or by any technique suitable for forming a substantially fluid-tight seal therebetween. As a non-limiting example, a flowed-material joint JNT can be formed as a weld joint and/or an adhesive joint between outer side wall portion 258 and end wall portion 288, such as along or otherwise between distal edges 262 and outer peripheral edge 294 respectively thereof, for example.

As discussed above, gas spring assemblies 102 and 200 are shown in FIGS. 1-3 as being supported during use in an installed condition between two masses or structural bodies, such as between vehicle body BDY and suspension component SPC or axle AXL and/or such as between upper and lower structural components USC and LSC. As such, the gas spring assemblies have an assembly height during use in operation, which is represented in FIG. 3 by reference dimension AH1, that corresponds to a normal height condition of the assembly. In some cases, such a normal height condition may be referred to as a design height. At such a design height, rolling lobe 224 of flexible spring member 206 is disposed approximately at a predetermined design position along outer side surface portion 264 of outer side wall portion 258 of end member assembly 204, which design height or position is represented in FIG. 3 by reference dimension DP1.

As gas spring assemblies 102 and/or 200 undergo changes in load conditions or dynamic inputs during use, the gas spring assemblies can be axially displaced toward a fully-extended (or rebound) condition in which end members 202 and 204 are disposed further apart from one another than at the design height. Alternately, the gas spring assemblies can be axially displaced in the opposite direction toward a fully-compressed (or jounce) condition in which end members 202 and 204 are disposed closer to one another than at the design height. As the gas spring assemblies are displaced away from the design height, rolling lobe 224 of flexible spring member 206 is displaced along outer side surface portion 264 of outer side wall portion 258 of end member assembly 204, such as is represented in FIG. 3 in dashed lines corresponding to a fully-compressed position CMP of rolling lobe 224, which is represented by reference dimension CP1 in FIG. 3.

It will be recognized and appreciated that the axial position of flowed-material joint JNT on or along end member assembly 204 is axially-offset or otherwise axially spaced apart from flexible spring member 206 (including rolling lobe 224 thereof) in the fully-compressed condition of the gas spring assembly, such as is represented by reference dimension OFS in FIG. 3. As such, outer side surface portion 264 of outer side wall portion 258 provides a smooth and continuous surface portion on or along which rolling lobe 224 of flexible spring member 206 can be displaced during dynamic use in operation as the gas spring assembly is extended and compressed toward and between fully-extended and fully-compressed heights. Such a zone or area of smooth and continuous surface is represented in FIG. 3 by reference characters SCS.

It will be appreciated that end member assembly 204 can be formed from any combination of one or more materials. In particular, it will be appreciated that end member sections 236 and 238 can be formed any combination of the same or different materials, including one end member section formed from one polymeric material and one or more end member section formed from a different polymeric material. Exemplary polymeric materials can include substantially rigid polymeric material, such as a fiber-reinforced polypropylene, a fiber-reinforced polyamide, or an unreinforced (i.e., relatively high-strength) thermoplastic (e.g., polyester, polyethylene, polyamide, polyether, or any combination thereof), for example.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted material or combination of melted materials) is deposited or otherwise presented between adjacent component parts and operative to form a fixed and substantially fluid-tight connection therebetween. Examples of processes that can be used to form such a flowed-material joint include, without limitation, conventional plastic welding processes (e.g., ultrasonic welding, spin welding, hot plate welding), such as may be formed from conventional wall configurations and/or weld joint geometry (e.g., shear joints, flange joints, tongue and groove joints). In such cases, one or more materials and/or combinations of materials can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood that claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. An end member assembly having a longitudinal axis and dimensioned to receivingly engage an associated flexible spring member for forming an associated gas spring assembly, said end member assembly comprising:
a first end member section including a first section wall extending peripherally about said longitudinal axis, said first section wall including:
a first end wall portion oriented transverse to said longitudinal axis;
a mounting wall portion extending from along said first end wall portion in a first axial direction, said mounting wall portion dimensioned to sealingly engage the associated flexible spring member;
a first outer side wall portion extending from along said first end wall portion in a second axial direction that is opposite said first axial direction toward a first outer distal edge that is axially offset from said first end wall portion by a first outer side wall distance, said first outer side wall portion disposed radially outward of said mounting wall portion and at least partially defining a first end member chamber; and,
a first inner side wall portion disposed radially inward of said first outer side wall portion and extending from along said first end wall portion toward a first inner distal edge that is axially offset from said first end wall portion by a first inner side wall distance that is less than said first outer side wall distance of said first outer side wall portion such that a recess extends into said first end member section from along said first outer distal edge, said recess having a frustoconical or concave shape projected between said first inner distal edge and said first outer distal edge; and,
a second end member section including a second section wall extending peripherally about said longitudinal axis, said second section wall including:
a second end wall portion oriented transverse to said longitudinal axis and including an outer peripheral edge; and,
a second inner side wall portion extending from along said second end wall portion in said first axial direction toward a second inner distal edge that is axially offset from at least one of said second end wall portion and said outer peripheral edge by a second inner side wall distance such that said second end member has a frustoconical or convex shape projected between said second inner distal edge and said outer peripheral edge of said second end wall portion;
said second end member section at least partially received within said recess of said first end member section such that said first and second inner distal edges are disposed adjacent one another, and said first and second end member sections connected to one another along a first flowed-material joint formed between said first outer distal edge and said outer peripheral edge such that a substantially fluid-tight seal is formed therebetween.

2. An end member assembly according to claim 1, wherein said first outer side wall portion includes a first outer side surface portion and a first inner side surface portion facing opposite said first outer side surface portion.

3. An end member assembly according to claim 2, wherein said first inner side wall portion includes a second outer side surface portion and a second inner side surface portion, said second outer side surface disposed in facing relation to said first inner side surface portion such that said first end member chamber is at least partially defined therebetween.

4. An end member assembly according to claim 3, wherein said second inner side surface portion at least partially defines a second end member chamber disposed radially inward of at least a portion of said first end member chamber.

5. An end member assembly according to claim 4, wherein said mounting wall portion at least partially defines an opening in fluid communication with at least said second end member chamber.

6. An end member assembly according to claim 4, wherein said first inner side wall portion includes a passage extending therethrough in fluid communication with said first and second end member chambers.

7. An end member assembly according to claim 6, wherein said passage is one of a plurality of passages disposed in peripherally-spaced relation to one another about said longitudinal axis.

8.-11. (canceled)

12. An end member assembly according to claim 1, wherein said first inner distal edge is disposed axially proximal to said mounting wall portion relative to said first outer distal edge.

13. An end member assembly according to claim 1, wherein said first and second inner distal edges are disposed axially proximal to said mounting wall portion relative to said first outer distal edge and said outer peripheral edge.

14. An end member assembly according to claim 1, wherein said first section wall of said first end member section includes a first plurality of outer rib walls extending between and operatively connecting said first outer side wall portion and said first inner side wall portion.

15. An end member assembly according to claim 14, wherein said first plurality of outer rib walls each extends axially toward a first distal rib edge.

16. An end member assembly according to claim 1, wherein said second section wall of said second end member section includes a second plurality of outer rib walls extending between and operatively connecting said outer peripheral edge and said second inner side wall portion.

17. An end member assembly according to claim 16, wherein said second plurality of outer rib walls each extends axially toward a second distal rib edge.

18. An end member assembly according to claim 14, wherein said first distal rib edges and said second distal rib edges are disposed in axially-spaced relation to one another such that an annular passage is at least partially formed therebetween.

19. An end member assembly according to claim 1, wherein a first profile reference line projecting from said first inner distal edge to said first outer distal edge swept around said longitudinal axis generates said recess with said frustoconical or concave shape.

20. An end member assembly according to claim 1, wherein a second profile reference line projecting from said second inner distal edge to said outer peripheral edge of said second end wall portion swept around said longitudinal axis generates said frustoconical or convex shape of said second end member section.

21. (canceled)

22. A gas spring assembly comprising:
a flexible spring member having a longitudinal axis and including a flexible wall extending peripherally about said longitudinal axis between a first end and a second end of said flexible spring member to at least partially define a spring chamber therebetween;
an end member secured across said first end of said flexible spring member such that a substantially fluid-tight connection is formed therebetween; and,
an end member assembly according to claim 1 secured across said second end of said flexible spring member such that a substantially fluid-tight connection is formed therebetween.

23. A gas spring assembly according to claim 22, wherein said gas spring assembly is displaceable during use from a design height toward a fully-compressed height at which said end member and said end member assembly are disposed closer to one another than at said design height,
said flexible spring member forming a rolling lobe along a first outer side surface portion of said first section wall with said rolling lobe disposed in a design position at said design height of said gas spring assembly and disposed in a compressed position at said fully-compressed height of said gas spring assembly such that said flowed-material joint of said end member assembly remains axially-offset from said rolling lobe of said flexible spring member in at least said fully-compressed height of said gas spring assembly.

24.-34. (canceled)

35. A gas spring assembly comprising:
a flexible spring member having a longitudinal axis and including a flexible wall extending peripherally about said longitudinal axis between a first end and a second end of said flexible spring member to at least partially define a spring chamber therebetween;
an end member secured across said first end of said flexible spring member such that a substantially fluid-tight connection is formed therebetween; and,
an end member assembly secured across said second end of said flexible spring member such that a substantially fluid-tight connection is formed therebetween, said end member assembly including:
a first end member section including a first section wall extending peripherally about said longitudinal axis, said first section wall including:
a first end wall portion oriented transverse to said longitudinal axis;
a mounting wall portion extending from along said first end wall portion in a first axial direction, said mounting wall portion dimensioned to sealingly engage said second end of said flexible spring member;
a first outer side wall portion extending from along said first end wall portion in a second axial direction that is opposite said first axial direction toward a first outer distal edge that is axially offset from said first end wall portion by a first outer side wall distance, said first outer side wall portion disposed radially outward of said mounting wall portion and at least partially defining a first end member chamber; and,
a first inner side wall portion disposed radially inward of said first outer side wall portion and extending from along said first end wall portion toward a first inner distal edge that is axially offset from said first end wall portion by a first inner side wall distance that is less than said first outer side wall distance of said first outer side wall portion such that a recess extends into said first end member section from along said first outer distal edge, said recess having a frustoconical or concave shape projected between said first inner distal edge and said first outer distal edge; and,
a second end member section including a second section wall extending peripherally about said longitudinal axis, said second section wall including:
a second end wall portion oriented transverse to said longitudinal axis and including an outer peripheral edge; and,
a second inner side wall portion extending from along said second end wall portion in said first axial direction toward a second inner distal edge that is axially offset from at least one of said second end wall portion and said outer peripheral edge by a second inner side wall distance such that said second end member has a frustoconical or convex shape projected between said second inner distal edge and said outer peripheral edge of said second end wall portion;
said second end member section at least partially received within said recess of said first end member section such that said first and second inner distal edges are disposed adjacent one another, and said first and second end member sections connected to one another along a flowed-material joint formed between said first outer distal edge and said outer peripheral edge such that a substantially fluid-tight seal is formed therebetween; and,
said gas spring assembly displaceable during use from a design height toward a fully-compressed height at which said end member and said end member assembly are disposed closer to one another than at said design height, said flexible spring member forming a rolling lobe along a first outer side surface portion of said first outer side wall potion of said first section wall with said rolling lobe disposed in a design position at said design height of said gas spring assembly and disposed in a compressed position at said fully-compressed height of said gas spring assembly such that said flowed-material joint of said end member assembly remains axially-offset away from said rolling lobe of said flexible spring member in at least said fully-compressed height of said gas spring assembly.

36. A gas spring assembly according to claim 35, wherein a first profile reference line projecting from said first inner distal edge to said first outer distal edge swept around said longitudinal axis generates said recess with said frustoconical or concave shape, and a second profile reference line projecting from said second inner distal edge to said outer peripheral edge of said second end wall portion swept around said longitudinal axis generates said frustoconical or convex shape of said second end member section.
